(19) United States
(12) Patent Application Publication
(10) Pub. No.: US 2004/0117309 A1
(43) Pub. Date: Jun. 17, 2004

(54) Content management system and information recording medium

(76) Inventors: Ryuji Inoue, Mino (JP); Shinichi Matsui, Kobe (JP); Naohiko Noguchi, Yokohama (JP); Mitsuhiro Sato, Atsugi (JP); Takashi Shimojima, Ota-ku (JP)

Correspondence Address: WENDEROTH, LIND & PONACK, L.L.P., 2033 K STREET N. W., SUITE 800, WASHINGTON, DC, 20006-1021, US

(21) Appl. No.: 10/471,615

(22) PCT Filed: Jul. 9, 2002
(86) PCT No.: PCT/JP02/06945

(30) Foreign Application Priority Data
Jul. 9, 2001 (JP) 2001-207482

(51) Int. Cl. G06F 17/60

(52) U.S. Cl. 705/50

(57) ABSTRACT

The present invention is directed to a content management system in which content data recorded on a memory card (1) is used by a content use terminal (2). The memory card (1) has recorded, in a protected area of which reading from outside is restricted, protected information including use restriction information indicative of conditions for using encrypted content data, and key information. The content use terminal (2) performs mutual authentication with the memory card (1). Furthermore, the content user terminal (2) reads the protected information from the protected area only when mutual authentication succeeds. Then, based on the use restriction information included in the read protected information, it is decided whether or not the content data recorded on the memory card (1) is usable. Also, the management server (3) transmits use restriction update information to the content use terminal (2) so as to update the use restriction information.

### TECHNICAL FIELD

The present invention relates to content management systems and information recording media and, more particularly, to a content management system in which a content recorded on a portable-type recording medium is used at a content use terminal, and an information recording medium used therein.

### BACKGROUND ART

In recent years, various types of schemes for supplying users with contents, such as programs and image data have been thought. In one exemplary type of scheme, a content recorded on a portable-type recording medium is distributed in advance to a user. In such type of scheme, when the user uses the content, his or her terminal transmits a request for using the content to a management server, and then receives a use permission from the management server, thereby enabling the use of the content. With the above system, a service model can be constructed as such that the server can perform processes, such as billing, in accordance with the request for using the content. Such a service model is a very useful in view of content providers.

One example of conventional art for achieving the above-described content providing system is an invention disclosed in Japanese Patent Laid-Open Publication No. 9-34841. FIG. 17 is a block diagram illustrating the configuration of a conventional content providing system. In FIG. 17, the content providing system includes a CD-ROM 91, a user PC 92 (terminal), a CD-ROM key-open center 93 (server), and a communications network 94. The CD-ROM 91 stores an encrypted content, and is distributed in advance to a user. To use the content, the user inserts the distributed CD-ROM 91 in the user PC 92 so as to transmit a request from the user PC 92 for purchasing the content stored in the CD-ROM 91. Upon receipt of the request via the communications network 94, the CD-ROM key-open center 93 transmits a key corresponding to the content requested to be purchased to the user PC 92. At this time, the CD-ROM key-open center 93 performs a billing process, etc., upon transmission of the key. Upon receipt of the key from the CD-ROM key-open center 93, the user PC 92 uses the key to decode the content in the CD-ROM 91 for use. With the above, the content in the CD-ROM can be provided offline.

As described above, in the content providing system where permission is required from the server in order to use a previously-distributed content, a use restriction is required so as not to allow free use of the distributed content. Conventionally, as described above, the use restriction is removed by receiving the encryption key itself for restricting the use of the content.

However, in the invention described in the above gazette, the use of the key transmitted from the CD-ROM key-open center 93 makes it possible to install a software program on a hard disk of the user PC 92. Therefore, once receiving the key, the user PC 92 can freely use the content thereafter. That is, once after receiving the key, the user can freely use the content as many number of times and hours as the user likes. As such, in such a conventional content managing scheme of restricting the use of a content only by a key transmitted from the server, the content provider cannot place restriction in detail in accordance with the amount of use or the use period of the content. For example, the content provider cannot perform billing in accordance with the state of use of the content, that is, the number of uses, the use time, etc., or cannot place restriction on a use period of the content to perform billing at renewal.

Therefore, an object of the present invention is to provide a content management system in which a content provider side can place use restriction in more detail regarding the use of a content.

### DISCLOSURE OF THE INVENTION

To achieve the above object, the present invention has features as described below.

A first aspect of the present invention is directed to a content management system in which content data recorded on a portable-type recording medium is used by a content use terminal, including:

the content use terminal;

a recording medium removably inserted to the content use terminal; and

a management server communicable with the content use terminal,

the recording medium including:

a content data recording section which records encrypted content data;

a medium-side authenticating section which performs authentication with the content use terminal; and

a protected area which records therein protected information of which reading from outside is restricted, the protected information including use restriction information indicative of conditions for using the encrypted content data and key information for decoding the encrypted content data, and

the content use terminal including:

a terminal-side authenticating section which performs mutual authentication with the recording medium in cooperation with the medium-side authenticating section;

a protected information reading section which reads the protected information from the protected area of the recording medium only upon a success of the mutual authentication performed by the terminal-side authenticating section with the recording medium;

a use deciding section which decides, based on the use restriction information included in the protected information read by the protected information reading section, whether or not the content data recorded on the recording medium is usable;

a content decoding section which decodes, upon a decision made by the use deciding section that the content data recorded on the recording medium is usable, the content data encrypted and recorded on the recording medium by using the key information included in the protected information read by the protected information reading section; and

a content executing section which executes the content data decoded by the content decoding section, wherein

the management server transmits, to the content use terminal, use restriction update information for updating the use restriction information,

the terminal-side authenticating section performs mutual authentication with the recording medium upon a receipt of the use restriction update information from the management server, and

the content use terminal further includes an updating section which updates, in accordance with the use restriction information transmitted from the management server, the use restriction information recorded in the protected area of the recording medium only upon success of the mutual authentication performed by the terminal-side authenticating section with the recording medium.

According to the above first aspect, the content data is executed upon a decision made based on the use restriction information that the content data is usable. As such, in the present aspect, the use of the content is restricted by the use restriction information. Also, since the use restriction information is recorded on the protected area, the details cannot be changed in an unauthorized manner. Therefore, by the content provider freely setting the use restriction information before distributing the recording medium, the use restriction of the content can be set in detail. Furthermore, according to the present aspect, with transmission of the use restriction update information from the management server, the use restriction information recorded on the recording medium is updated. Since the details of the use restriction update information is set by the management server side, the use restriction information can be freely changed by the management server side by using the use restriction information. Therefore, the management server side, that is, the content manager (provider) can set the use restriction of the content by the use restriction information in more detail.

According to a second aspect based on the first aspect,

the content use terminal further includes a use requesting section which transmits, to the management server, upon a decision by the use deciding section that the content data recorded on the recording medium is not usable, use request information indicative of a request for using the content data decided as not being usable,

upon a receipt of the use request information from the use requesting section of the content use terminal, the management server transmits, to the content use terminal, use restriction update information regarding the content data requested by the transmitted use request information, and

upon an update performed by the updating section of the use restriction information recorded on the protected area, the content decoding section decodes the content data regarding the updated use restriction information.

According to the above second aspect, upon a determination made based on the use restriction information that the content is not usable, the use restriction update information is transmitted from the management server to the content use terminal. Therefore, even with a determination that the content is not usable, the use restriction information is changed in accordance with the use request, and therefore the content data can be executed.

According to a third aspect based on the second aspect, the protected information further includes a content identifier for identifying the content data recorded on the recording medium,

the use requesting section transmits, to the management server, as a use request, use request information including the content identifier indicative of the content data requested by the use request, and

the management server transmits, to the content use terminal, the use restriction update information regarding the content data indicated by the content identifier transmitted from the use requesting section of the content use terminal.

According to the above third aspect, the content data indicated by the use request is specified by the content identifier. Also, since the content identifier is recorded on the recording medium, the content use terminal does not have to hold, in advance, information for specifying the content data indicated by the use request. Therefore, according to the present aspect, the content use terminal can easily specify the content data indicated by the use request.

According to a fourth aspect based on the first aspect, the use restriction update information is information indicative of conditions for using the content data, and the updating section updates the use restriction information recorded on the protected area of the recording medium so that conditions indicated by the use restriction information are identical to the conditions indicated by the use restriction update information transmitted from the management server.

According to the above fourth aspect, the use restriction

update information has the same details as those of the use restriction information. Therefore, when the use restriction information recorded on the recording medium is updated by the use restriction update information, the use restriction update information held at the management server side indicates the same details as those indicated by the use restriction information held in the recording medium. With the above, according to the present aspect, it is possible at the management server side to grasp the details of the use restriction information recorded on the recording medium without generating a specific database that represents use history.

According to a fifth aspect based on the first aspect,

the use restriction update information is information indicative of an amount of change in the use restriction information recorded on the recording medium between before and after the update, and

based on the amount of change indicated by the use restriction update information transmitted from the management server, the updating section updates the use restriction information recorded on the protected area of the recording medium.

According to the above fifth aspect, irrespectively of the details of the use restriction information recorded on the recording medium, the amount of use of the content can be equally changed for the content use terminals which transmit the use restriction update information. Therefore, by transmitting the same use restriction update information from the management server to a plurality of content use terminals, the content provider can provide the same service to users of the content use terminals.

According to a sixth aspect based on the first aspect,

the content use terminal further includes:

a use restriction update information storage section which stores the use restriction update information transmitted from the management server; and

a use restriction information deciding section which makes a decision about whether or not the protected information recorded on the recording medium includes use restriction information corresponding to the use restriction update information stored in the use restriction update information storage section, the decision being made only upon a success of the mutual authentication performed by the terminal-side authenticating section with the recording medium,

upon new insertion of a recording medium, the terminal-side authenticating section performs mutual authentication with the newly-inserted recording medium, and

upon a decision made by the use restriction information deciding section that the use restriction information corresponding to the use restriction update information stored in the use restriction update information storage section is included, the updating section updates the use restriction information recorded on the recording medium in accordance with the use restriction update information stored in the use restriction update information storage section.

According to the above sixth aspect, the content use terminal decides whether or not to update the use restriction information whenever a recording medium is inserted. Here, when the management server transmits the use restriction update information, the recording medium has not necessarily been inserted in the content use terminal. According to the present aspect, however, even when the use restriction information cannot be updated because no recording medium is inserted at the time of reception of the use restriction update information, the use restriction information can be updated if a recording medium is inserted thereafter. Therefore, it is ensured that the use restriction information can be updated by using the use restriction update information transmitted from the management server.

According to a seventh aspect based on the sixth aspect,

the content use terminal further includes a discarding section which discards, upon an update by the updating section of the use restriction information, the use restriction update information corresponding to the updated use restriction information from the use restriction update information storage section.

According to the above seventh aspect, the use restriction update information is discarded from the use restriction update information storage section. Therefore, it is possible to prevent the use restriction information from being updated by the same use restriction update information and to prevent a meaningless updating process.

According to an eighth aspect based on the seventh aspect,

the management server transmits, to the content use terminal, the use restriction update information together with updatable period information indicative of a period during which the use restriction information can be updated by the use restriction update information,

the use restriction update information storage section further stores the updatable period information transmitted from the management server,

the content use terminal further includes an update deciding section which makes a decision based on the updatable period information stored in the use restriction update information storage section about whether or not the use restriction update information recorded on the recording medium is to be updated, upon a decision made by the use restriction information deciding section that the use restriction information corresponding to the use restriction update information stored in the use restriction update information storage section is included,

the updating section updates the use restriction information only upon a decision made by the updating decision section that the use restriction information is to be updated, and

upon a decision made by the update deciding section that the use restriction information is not to be updated, the discarding section discards the use restriction update information and the updatable period information corresponding to the use restriction information decided as being not to be updated from the use restriction update information storage section.

According to the above eighth aspect, the use restriction update information updates the use restriction information recorded on the recording medium only within the period indicated by the updatable period information. Also, if an updating process is not performed within the updatable period, the use restriction update information whose updatable period has passed is discarded from the use restriction update information. Therefore, according to the present aspect, it is possible to prevent a wasteful process of deciding whether or not to update by the use restriction update information that is not necessary because no updating process is performed.

According to a ninth aspect based on the first aspect,

the content use terminal further includes a retrieval requesting section which transmits retrieval request information indicative of a retrieval request for requesting a retrieval of the content data to the management server; and

a recording section which records in the recording medium, only upon a success of the mutual authentication performed by the terminal-side authenticating section with the recording medium, information transmitted from the management server in response to the retrieval request information transmitted from the retrieval request,

the management server transmits, to the content use terminal, the encrypted content data indicated by the retrieval request information transmitted from the retrieval requesting section of the content use terminal, the use restriction information regarding the content data, and the key information for decoding the content data, and

the recording section records at least the use restriction information and the key information of the information transmitted from the management server in the protected area.

According to the above ninth aspect, the content use terminal can retrieve the content from the management server by a retrieval request. Furthermore, the use restriction information and the key information of the retrieved content are recorded in the protected area of the recording medium. Therefore, unauthorized use can be prevented.

According to a tenth aspect based on the ninth aspect,

the protected area has further recorded therein a content identifier for identifying a content recorded on the recording medium,

the retrieval requesting section transmits information including the content identifier recorded on the recording medium as the retrieval request information at the time of retrieving the content data related to the content data recorded on the recording medium, and

the management server transmits, to the content use terminal, the encrypted content data which corresponds to content data indicated by a content identifier transmitted from the retrieval requesting section, the use restriction information regarding the content data, and the key information for decoding the content data.

According to the tenth aspect, the content use terminal can newly retrieve content data related to the content data recorded on the recording medium. With this, the user can easily retrieve a content other than the content that has already been owned. Therefore, the user can have more opportunities to retrieve a new content. For the content provider side, this leads to the promotion of the use of contents.

According to an eleventh aspect based on the tenth aspect,

in addition to the content identifier, the retrieval requesting section transmits, to the management server, the use restriction information corresponding to the content data indicated by the content identifier, and

the management server changes details of the use restriction information to be transmitted to the content use terminal in accordance with details of the use restriction information transmitted from the retrieval requesting section.

According to the above eleventh aspect, the use restriction information regarding the newly-retrieved content is changed in accordance with the details of the use restriction information transmitted as the retrieval request. That is, in a case where there are a plurality of content use terminals, the management server can change the details of the use restriction information for each content use terminal transmitting a retrieval request. Therefore, it is possible to place use restriction in detail for each content use terminal.

According to a twelfth aspect based on the first aspect,

the use restriction information includes at least one of number-of-uses limit information indicative of the number of times the content data recorded on the recording medium can be used, time limit information indicative of a time during which the content data recorded on the recording medium can be used, and date/time limit information indicative of a date/time by which the content data recorded on the recording medium can be used.

According to the twelfth aspect, the content provider can set the use restriction information so that the use of the content data is restricted by any one of the number of uses, the use time, and the use date/time.

A thirteenth aspect is directed to a portable-type information recording medium removably attached to a content use terminal using content data, including:

a content data recording section which records encrypted content data;

a medium-side authenticating section which performs authentication with the content use terminal as a part of a mutual authentication process performed with the content use terminal; and

a protected area which records protected information including a content identifier for identifying the content data, use restriction information indicative of conditions for using the encrypted content data, and key information for decoding the encrypted content data, the protected information of which reading from outside being restricted, wherein

the protected area can be read by the content use terminal only upon a success of the mutual authentication process performed with the content use terminal.

According to a fourteenth aspect based on the thirteenth aspect,

the use restriction information includes at least one of number-of-uses limit information indicative of the number of times the content data can be used, time limit information indicative of a time during which the content data can be used, and a date/time limit information indicative of date/time by which the content data can be used.

### BRIEF DESCRIPTION OF THE DRAWINGS

FIG. 1 is a block diagram illustrating the configuration of a content management system according to a first embodiment of the present invention.

FIG. 2 is an illustration showing the structure of files and their directory recorded on a memory card illustrated in FIG. 1.

FIG. 3 is a block diagram illustrating the hardware structure of a content use terminal 2 illustrated in FIG. 1.

FIG. 4 is a block diagram illustrating a functional structure of the content use terminal 2 illustrated in FIG. 1.

FIG. 5 is a flowchart showing a flow of a process performed by the content use terminal 2 in a first operation example.

FIG. 6 is a flowchart showing the details of step S105 illustrated in FIG. 5.

FIG. 7 is a block diagram illustrating a functional structure of a management server 3 illustrated in FIG. 5.

FIG. 8 is an illustration showing a use restriction update table held in the management server 3 according to the first embodiment.

FIG. 9 is a flowchart showing a flow of a process performed by the management server 3 in the first operation example.

FIG. 10 is an illustration showing a flow of one example of a use restriction update table in another embodiment.

FIG. 11 is a flowchart showing a flow of a process performed by the management server 3 in a second operation example.

FIG. 12 is an illustration showing one example of a transmission destination table held in the management server 3 in the second operation example.

FIG. 13 is a flowchart showing a flow of a process performed by the content use terminal 2 in the second operation example.

FIG. 14 is a flowchart showing a flow of a process performed by the content use terminal 2 in a third operation example.

FIG. 15 is a flowchart showing a flow of a process performed by the management server 3 in the third operation example.

FIG. 16 is an illustration of one example of a related content table held in the management server 3 in the third operation example.

FIG. 17 is an illustration conceptually showing the configuration of a content management system according to a second embodiment.

FIG. 18 is a block diagram illustrating the configuration of a conventional content providing system.

### BEST MODE FOR CARRYING OUT THE INVENTION

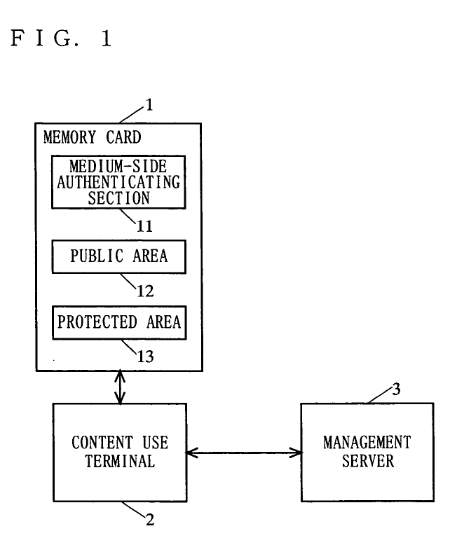

FIG. 1 is a block diagram illustrating the configuration of a content management system according to a first embodiment of the present invention. In FIG. 1, the content management system includes a memory card 1, a content use terminal 2, and a management server 3. Communication between the content use terminal 2 and the management server 3 is performed via a network not shown. The memory card 1 is a portable-type recording medium. Also, the memory card 1 is removably inserted in the content use terminal 2. Content data is recorded on the memory card 1.

To use the content data, the content use terminal 2 accesses the memory card 1. To access a protected area 13 of the memory card 1, mutual authentication is performed between the memory card 1 and the content use terminal 2. If the protected area 13 of the memory card 1 is accessible, the content use terminal 2 determines, based on use restriction information recorded on the protected area 13 of the memory card 1, whether the content data is usable or not. Here, the use restriction information is information indicative of conditions for use of the content data. The content use terminal 2 executes the content data only upon a determination that the content data is usable. In the present embodiment, the use of the content data is restricted by the use restriction information recorded on the memory card 1 in the above-described manner.

Upon a determination that the content data is not usable, the content use terminal 2 transmits a content identifier to a content server. Here, the content identifier is information for identifying the content data, the information being unique to the content data. The management server 3 transmits the use restriction information regarding the content data indicated by the received content identifier to the content use terminal 2. The details of the use restriction information recorded on the memory card 1 are updated to the details of the use restriction information transmitted from the management server 3. With this, the content use terminal 2 can use the content data.

Next, the memory card 1 is described in detail. As illustrated in FIG. 1, the memory card 1 includes a medium-side authenticating section 11, a public area 12, and the protected area 13. The medium-side authenticating section 11 performs an authenticating process at the memory card 1 side of mutual authentication between the memory card 1 and the content use terminal 2. The authenticating process performed by the medium-side authenticating section 11 forms part of the mutual authenticating process performed by the memory card 1 and the content use terminal 2. Note that, in the present embodiment, the medium-side authenticating section 11 is achieved by a CPU included in the memory card 1 executing a predetermined authenticating process program. The protected area 13 is an area which is accessible only after successful mutual authentication between the memory card 1 and the content use terminal 2. Furthermore, the public area 12 is an area accessible without such mutual authentication.

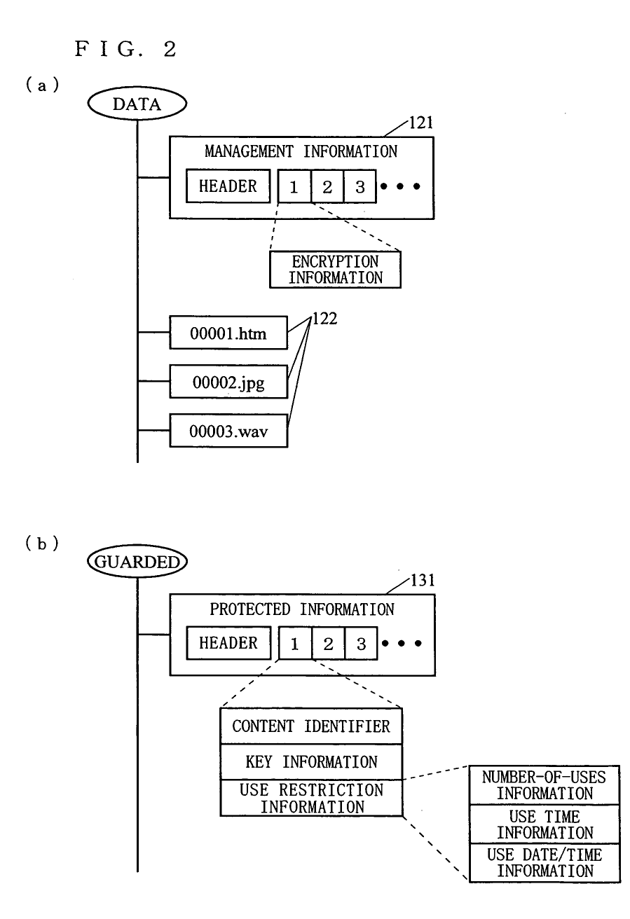

FIG. 2 is an illustration showing the structure of files and their directory recorded on the memory card 1 illustrated in FIG. 1. The memory card 1 is distributed to each user after having information illustrated in FIG. 2 recorded in advance. Note that the information recorded on the memory card 1 illustrated in FIG. 2 can be obtained through, for example, wired or wireless data communications with a predetermined server (the management server 3 or another dedicated server), or can be obtained in a form of broadcasting. Furthermore, the information can be obtained through reading from another information recording medium.

FIG. 2(a) is an illustration showing the structure of files and their directory recorded on the public area l2. Also, FIG. 2(b) is an illustration showing the structure of files and their directory recorded on the protected area 13. The public area 12 has recorded therein encrypted content data and management information for managing the encrypted content data. Specifically, the public area 12 has content files 122 and a manager file 121 recorded in a specific directory (denoted as “DATA” illustrated in FIG. 2(a)). Note that the content files 122 are files having stored therein encrypted content data. Also, the files illustrated in FIG. 2(a) have file names of “0001.htm”, “00002.jpg”, and “00003.wav”. The manager file l2l is a file having stored therein management information for managing the content files 122. Also, in FIG. 2(b), the protected area 13 has recorded therein a protected information file 131 in a specific directory (denoted as “GUARDED” in FIG. 2(b)). The protected information file 131 includes at least the above-described content identifier and use restriction information. Here, the above-stated two directories correspond to each other. That is, the protected information regarding the content files 122 placed in the directory of the public area 13 are recorded on the protected information file 131 located in the directory of the protected area 13.

The content files 122 each have a file name of “five-digit number+extension”. The manager file l2l is composed of management information and a header for managing the same. The number of pieces of management information corresponds to the number of pieces of content data. Furthermore, the pieces of management information respectively correspond to the pieces of content data. That is, an n-th piece of management information corresponds to the content file 122 having the file name of “n+extension”. For example, the first piece of management information corresponds to a content file 122 having a file name of “00001.htm”. Here, the management information includes encryption information. The encryption information is information indicative of whether the corresponding content file 122 has been encrypted or not. Therefore, the content use terminal 2 can determine, based on the details of the encryption information, whether the content data has been encrypted or not.

The protected information file 131 is composed of protected information and a header for managing the same. As with the above management information, the number of pieces of protected information corresponds to the number of pieces of content data. Also, the pieces of protected information respectively correspond to the pieces of content data. That is, an n-th piece of protected information corresponds to a content file 122 having a file name of “n+extension”. For example, the first piece of protected information corresponds to the content file 122 having the file name of “00001.htm”. The protected information includes the above-stated content identifier, key information, and use restriction information. The key information is information indicative of an encryption key for decoding the encrypted content data. Therefore, the terminal (including a terminal not having a function of mutual authentication) cannot use the content data by merely accessing the public area, until the terminal also accesses to the protected area to obtain the key information.

Also, the use restriction information indicates information regarding restriction on the use of the corresponding content data. In the present embodiment, the use restriction information includes number-of-uses information, use time information, and use date/time information. The number-of-uses information is information indicative of the number of times the content data can be used. In the present embodiment, the number-of-uses information includes information indicative of a predetermined number of times the content data can be used and information indicative of a total number of times the content data has been used. For example, the number-of-uses information includes information indicating that the number of times predetermined as a limit on the number of uses is five and that the total number of times the content data has been used so far is three. With this, it can be known that the remaining number of times the content data can be used is two. The use time information is information indicative of a time period during which the content data can be used. In the present embodiment, the use time information includes information indicative of a predetermined time period during which the content data can be used and a total time period during which the content data has been used so far. For example, the use time information has recorded therein information indicating that the time period predetermined as a use time limit is twelve hours and that the total use time so far is five hours. The use date/time information is information indicative of date(s) and time(s) during (by) which the content data can be used. The use date/time information has recorded therein, for example, information indicating that a time period during which the corresponding content data can be used is from the first day of August, 2001 through the thirty-first day of December, 2001.

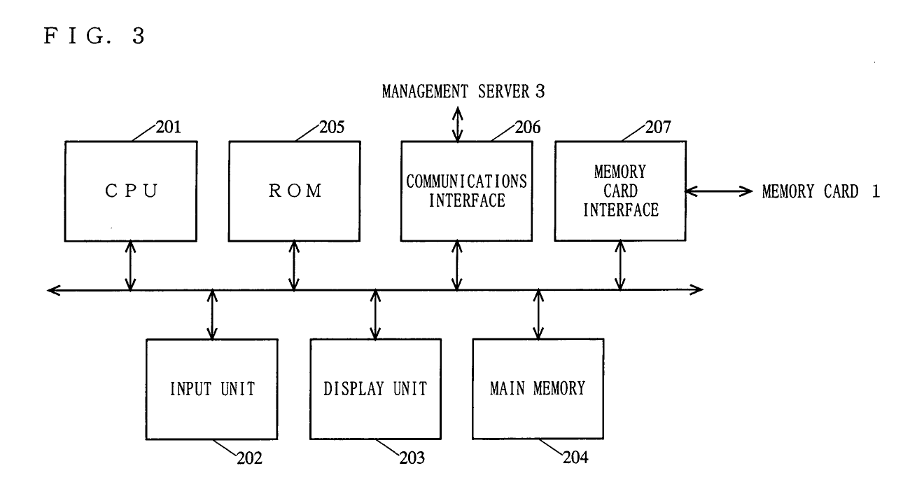

Next, the content use terminal 2 is described in detail. FIG. 3 is a block diagram illustrating the hardware structure of the content use terminal 2 illustrated in FIG. 1. The content use terminal 2 has a function of reading a content and a function of listening a sample of the content and replaying the content. Note that the content use terminal 2 is implemented as a personal computer for executing a program achieving these functions. In FIG. 3, the content use terminal 2 includes a central processing unit (hereinafter referred to as “CPU”) 201, an input unit 202, a display unit 203, a main memory 204, a read-only memory (hereinafter referred to as “ROM”) 205, a communications interface 206, and a memory card interface 207. The CPU 201 executes a program stored in the ROM 205 by using the main memory 204, Data transmission/reception between the content use terminal 2 and the server via the external network (not shown) is performed via the communications interface 206. Reading and writing of the memory card 1 is performed via the memory card interface 207. Also, the content use terminal 2 in the present embodiment can have a structure having a function of recording a content as well as the above-mentioned functions. In this case, it is possible for the content use terminal 2 to retrieve content data via the communications interface 206 from outside (for example, the management server 3) and then record the retrieved data on the memory card 1.

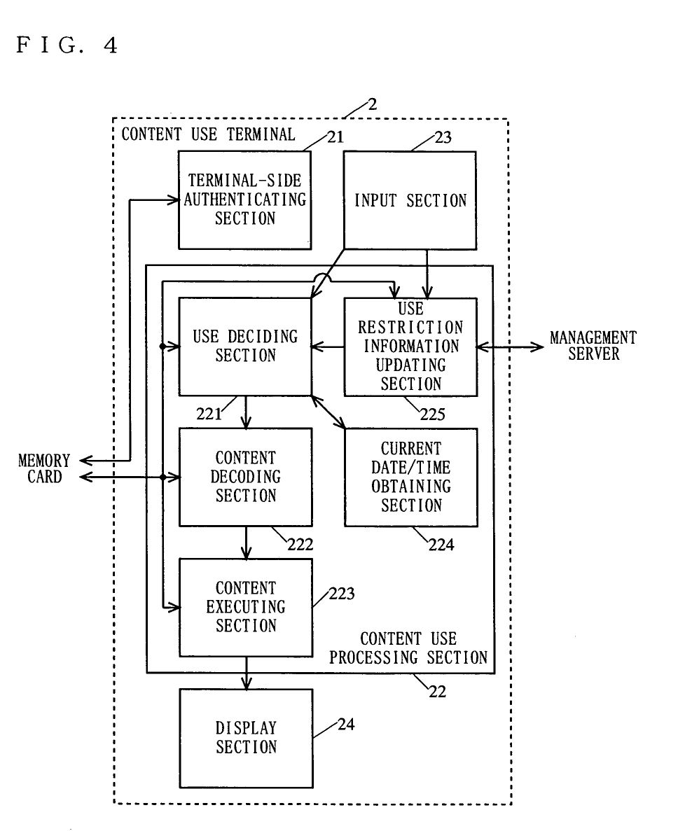

FIG. 4 is a block diagram illustrating a functional structure of the content use terminal 2 illustrated in FIG. 1. In FIG. 4, the content use terminal 2 includes a terminal-side authenticating section 21, a content use processing section 22, an input section 23, and a display section 24. The input section 23 and the display section 24 are implemented by the input unit 202 and the display unit 203, respectively, illustrated in FIG. 3. In the present embodiment, the terminal-side authenticating section 21 and the content use processing section 22 are achieved by the CPU 201 executing a predetermined program stored in the ROM 205.

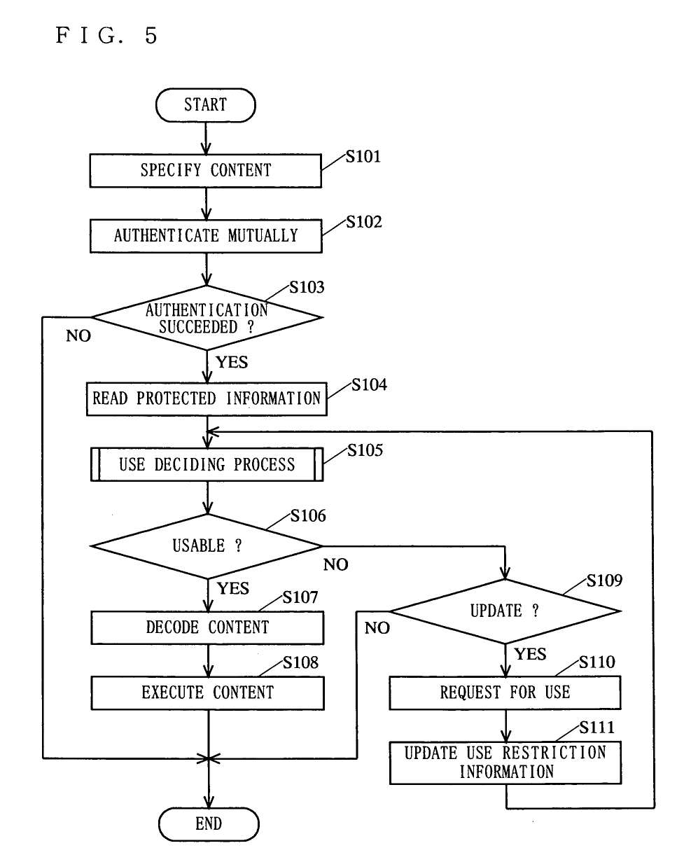

A first operation example performed in the content management system according to the present embodiment is described below. In the first operation example below, the operation performed when the content use terminal 2 uses the content data recorded on the memory card 1 is described. FIG. 5 is a flowchart showing a flow of a process performed by the content use terminal 2 in the first operation example. To use the content data recorded on the memory card 1 inserted in the content use terminal 2, the content use terminal 2 first specifies a piece of content data for use (step S101). That is, the input section 23 accepts an instruction from the user for specifying a piece of content data for use. The input section 23 is supplied with the instruction from the user for specifying the piece of content data for use from out of pieces of content data recorded on the memory card 1. That is, the user specifies a desired piece of content data for use by using the input unit 202. With this, based on the instruction from the input unit 23, the content use terminal 2 can specify the piece of content data for use.

Next, in order to determine whether the specified piece of content data is usable or not, the content use terminal 2 has to read the use restriction information from the memory card 1. The use restriction information, however, is recorded on the protected area 13 of the memory card 1. Therefore, the content use terminal 2 performs mutual authentication with the memory card 1 (step S102) Here, mutual authentication is performed by the medium-side authenticating section 11 and the terminal-side authenticating section 21 cooperating with each other as follows. That is, the content use terminal 2 passes a previously-set device key of its own to the medium-side authenticating section 11 of the memory card 1. The memory card 1, on the other hand, passes a previously set memory card key of its own to the terminal-side authenticating section 21 of the content use terminal 2. Based on the respectively received keys, the medium-side authenticating section 11 of the memory card 1 and the terminal-side authenticating section 12 of the content use terminal 2 authenticate with each other. The authentication results of the medium-side authenticating section 11 is reported to the content use terminal 2. Based on the authentication results of the medium-side authenticating section 11 and the terminal-side authenticating section 21, the content use terminal 2 determines whether mutual authentication has succeeded. That is, if the authenticating processes performed by the medium-side authenticating section 11 and the terminal-side authenticating section 21 have succeeded, the content use terminal 2 determines that mutual authentication has succeeded. Conversely, if either or both of the authenticating processes performed by the medium-side authenticating section 11 and the terminal-side authenticating section 21 have failed, the content use terminal 2 determines that mutual authentication has failed. For example, mutual authentication fails if the terminal does not have a function of reading the protected area or if the terminal is set by the memory card side so as to be prohibited to read the protected area. Note that the medium-side authenticating section 11 and the terminal-side authenticating section 21 can be achieved by the CPU for executing a predetermined authentication program for the mutual authentication process, or can be achieved by a chip dedicated to the mutual authentication process.

Next, the content use terminal 2 determines whether mutual authentication in step S102 has succeeded or not (step S103). With mutual authentication being successfully completed, the content use terminal 2 can access the protected area 13 of the memory card 1. Therefore, if mutual authentication has failed, the content use terminal 2 ends the process without performing a content using process in step S103 and thereafter. On the other hand, if mutual authentication has succeeded, the content use terminal 2 performs the content using process in step S104 and thereafter. The content using process is described below.

The content using process is performed by the content use processing section 22 of the content use terminal 2. Here, as illustrated in FIG. 4, the content use processing section 22 includes a use deciding section 221, a content decoding section 222, a content executing section 223, a current date/time obtaining section 224, and a use restriction information updating section 225. Note that the content use processing section 22 is achieved by the CPU 201 executing a content use processing program for performing the content use processing. Also, each component included in the content use processing section 22 represents a subroutine in the content use processing program.

In the content use process, the content use processing section 22 first reads the protected information regarding the content data specified in step S101 recorded on the protected area 13 (step S104). The content use processing section 22 then performs a use decision process (step S105). Here, the use decision process is performed by the use deciding section 221. That is, the use deciding section 221 obtains the protected information corresponding to the specified content data from the memory card 1. Based on the use restriction information (the number-of-uses information, the use time information, and the use date/time information) included in the obtained protected information, the use deciding section 221 decides whether the content data is usable or not. The use decision process is described below in detail.

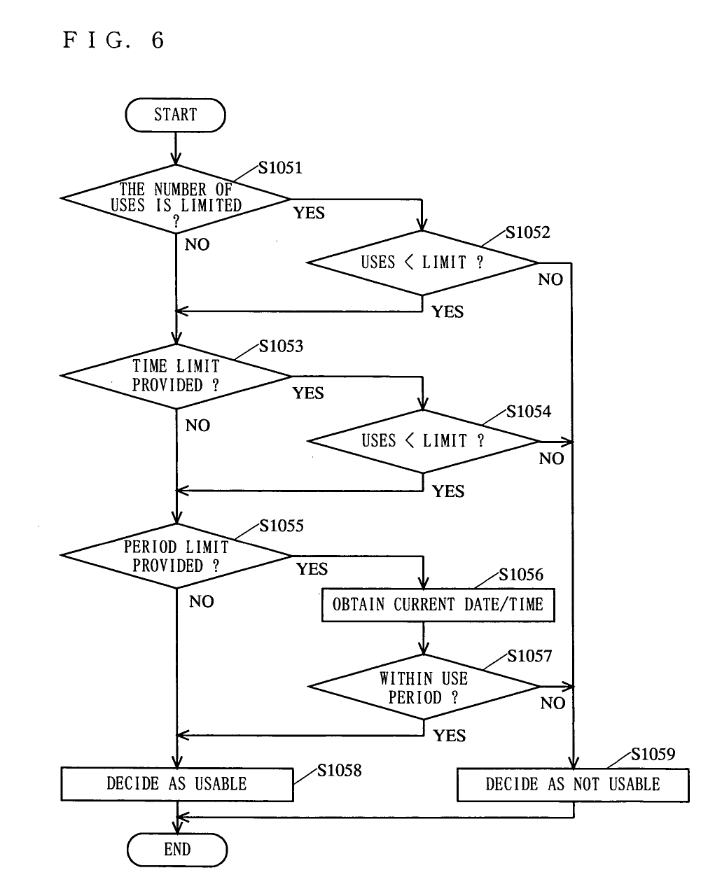

FIG. 6 is a flowchart showing the details of step S105 shown in FIG. 5. First, the use deciding section 221 decides whether or not the number of uses is limited, that is, whether the obtained use restriction information has set therein number-of-uses information or not (step S1051). If it is decided in step S1051 that the number-of-uses information has not been set, the use deciding section 221 performs a process of step S1053. If it is decided in step S1051 that the number-of-uses information has been set, on the other hand, the use deciding section 221 decides based on the number-of-uses information whether or not the total number of uses so far is smaller than the predetermined limit on the number of uses (step S1052). If it is decided in step S1052 that the total number of uses so far is smaller than the predetermined limit on the number of uses, the use deciding section 221 performs a process of step S1053. On the other hand, if it is decided in step S1052 that the total number of uses so far is equal to or larger than the predetermined limit on the number of uses, the use deciding section 221 decides that the content data is not usable, and then ends the use decision process.

In step S1053, the use deciding section 221 decides whether or not the use time is limited, that is, whether or not the obtained use restriction information has set therein use time information. If it is decided in step S1053 that the use time information has not been set, the use deciding section 221 performs a process of step S1055. If it is decided in step S1053 that the use time information has been set, on the other hand, the use deciding section 221 decides based on the number-of-uses information whether the total use time so far is smaller than the predetermined use time limit (step S1054). If it is decided in step S1054 that the total use time so far is less than the use time limit, the use deciding section 221 performs the process of step S1055. If it is decided in step S1054 that the total use time so far is equal to or larger than the use time limit, the use deciding section 221 decides that the content data is not usable (step S1059), and then ends the use decision process.

In step S1055, the use deciding section 221 decides whether or not the use time/date is limited, that is, whether or not the obtained use restriction information has set therein the use date/time information. If it is decided in step S1055 that the use date/time information has not been set, the use deciding section 221 performs a process of step S1058. On the other hand, if it is decided in step S1055 that the use date/time information has been set, the use deciding section 221 receives an input of the current date/time from the current date/time obtaining section 224 (step S1056). Here, the current date/time obtaining section 224 obtains the current date/time by, for example, using a clock internally provided to the content use terminal 2 or accessing, via a network, an external server announcing the current date/time. After step S1056, based on the current date/time and the use date/time information obtained in step S1056, the use deciding section 221 decides whether or not the current date/time is within a range of the use date/time limit (step S1057). If it is decided in step S1057 that the current date/time is within the range of the use date/time limit, the use deciding section 221 decides that the content data is usable (step S1058), and then ends the use decision process. If it is decided in step S1057 that the current date/time is not within the range of the use date/time limit, on the other hand, the use deciding section 221 decides that the content data is not usable (step S1059), and then ends the use decision process. With the above use decision process, the use deciding section 221 can decide whether or not the content data is usable.

Returning to the descriptions of FIG. 5, the content use processing section 22 then decides whether or not the decision result in step S105 is “usable” (step S106). If it is decided instep 106 that the decision result of the use deciding section 221 shows that the content data is usable, the content use processing section 22 reads the content file 122 from the memory card 1 to decode the content data (step S107). The content data decoding process is performed by the content decoding section 222. That is, the content decoding section 222 uses the key information obtained in step S104 to decode the encrypted content data recorded on the memory card 1. Note that the decision result obtained through the use decision process is reported from the use deciding section 221 to the content decoding section 222.

Next, the content executing section 223 executes the content data supplied by the content decoding section 222 (step S108). The content executing section 223 performs a replay/execution according to the type of the content file 122. Also, the content executing section 223 displays the content data by using the display section 24 as required. Furthermore, the content executing section 223 accesses the use restriction information of the memory card 1 to update the use restriction information. Specifically, the content executing section 223 updates the total number of uses of the use time information and the total use time of the number-of-uses information included in the use restriction information. For example, the content executing section 223 performs a process, such as a process of incrementing the total number of uses by one or a process of adding the present use time to the total use time.

On the other hand, if it is decided in step S106 that the decision result of the use deciding section 221 shows that the content data is not usable, the content use processing section 22 decides whether or not to update the use restriction information (step S109). That is, the content use processing section 22 inquires of the user about whether or not to update the use restriction information. Specifically, the display section 24 is caused to display a message indicating that the content data is not usable. Furthermore, the content use processing section 22 waits for an instruction input from the user regarding whether the use restriction information is to be updated or not. In response, the user uses the input unit 202 to make an instruction about whether or not to update the use restriction information. In the present embodiment, the input unit 23 accepts, as the instruction from the user, only either one input of “update the use restriction information” and “do not update the use restriction information”. Based on this input, the content use processing section 22 decides whether or not to update the use restriction information. In step S109, if an instruction indicative of not updating the use restriction information is supplied to the input section 23, the content use processing section 22 ends the content use process.

On the other hand, in step S109, if an instruction indicative of updating the use restriction information is supplied to the input section 23, the content use processing section 22 transmits use request information to the management server 3 as a request for using the content data (step S110). The use request information is information indicative of a request for using the content data. In the present embodiment, the content use processing section 22 transmits, to the management server 3 as the request for using the content data, the use request information including the content identifier included in the protected information obtained from the memory card 1. Note that a user identifier unique to the user is also transmitted together with the content identifier. The user identifier indicates information for identifying the user. The user identifier may be set to the user by the content provider. Also, when the content identifier is transmitted via email, a mail address can be used as the user identifier. Upon receipt of the content identifier, the management server 3 transmits use restriction update information corresponding to the content identifier to the content use terminal 2. Here, the use restriction update information is information for updating the use restriction information recorded on the memory card 1. A process performed by the management server 3 is described below in detail.

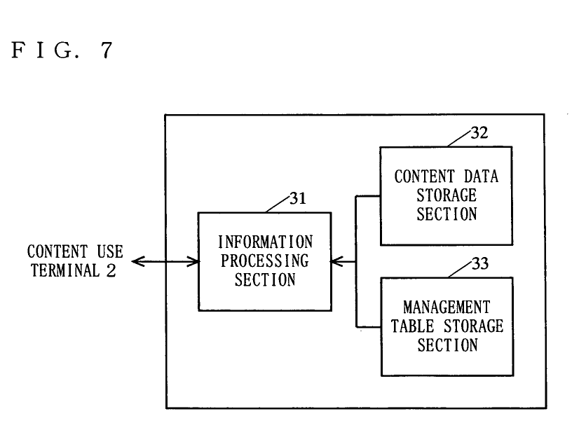

FIG. 7 is a block diagram illustrating a functional structure of the management server 3 illustrated in FIG. 1. In FIG. 7, the management server 3 includes an information processing section 31, a content data storage section 32, and a management table storage section 33. The information processing section 31 is achieved by the CPU included in the management server 3 executing a program for performing a predetermined process shown by a flowchart, which will be described further below. The content data storage section 32 stores pieces of content data to be used by the content use terminal 2. Also, the content data storage section 32 stores the pieces of the content data together with their content identifiers in a relational manner. Note that, in a first operation example, the management server 3 may have a structure without the content data storage section 32. The management table storage section 33 stores various tables, which will be described further below. Note that the management server 3 is implemented as a personal computer that executes the above-mentioned functions through program processing.

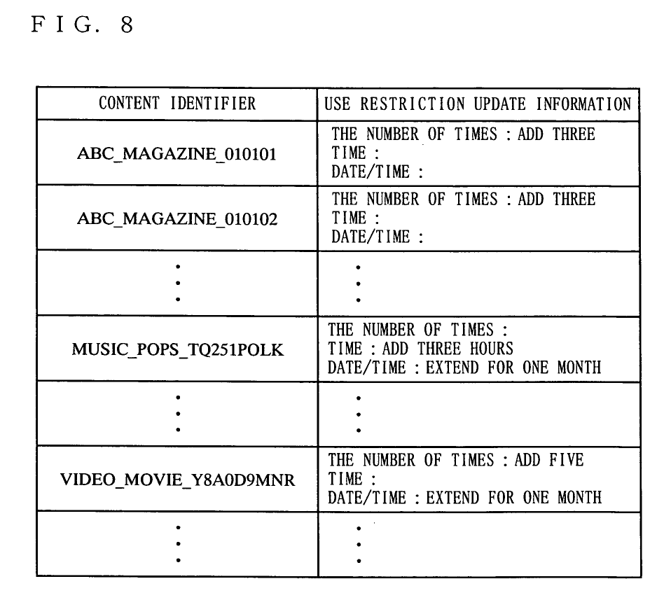

FIG. 8 is an illustration showing a use restriction update table stored in the management table storage section of the management server 3 according to the first embodiment. As illustrated in FIG. 8, the use restriction update table stores the content identifiers and the use restriction update information in a relational manner. Here, the use restriction update table is generated for each user. That is, the management server 3 holds the use restriction update tables as many as the number of registered users.

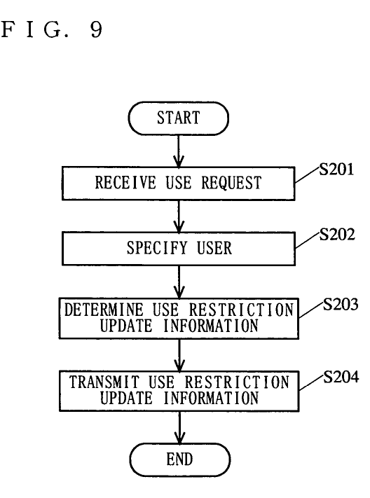

FIG. 9 is a flowchart showing a flow of a process performed by the management server 3 in the first operation example. First, the management server 3 receives use request information from the content use terminal 2 (step S201) to specify the user who made the request for updating the use restriction information (step S202). Specifically, based on the user identifier transmitted together with the content identifier, the management server 3 specifies the use restriction update table to be referred to from out of the use restriction update tables held in the management server 3. The management server 3 then determines which use restriction update information is to be transmitted (step S203) Specifically, by referring to the use restriction update table specified in step S202, the management server 3 specifies the use restriction update information corresponding to the content identifier received from the content use terminal 2. Furthermore, the management server 3 transmits the specified use restriction update information to the content use terminal 2 (step S204). Taking FIG. 8 as an example for description, in a case where a content identifier of “ABC_MAGAZINE_{—}0101011” has been transmitted from the content use terminal 2, the management terminal transmits use restriction update information of “the number of times: add three”. Note that the use restriction update information of “the number of times: add three” indicates that a limit on the number of uses that is included in the number-of-uses information recorded on the memory card is added with three for update. Also, in FIG. 8, the use restriction update information of “time: add three hours, date/time: extend for one month” indicates that the use time limit included in the use time information recorded on the memory card 1 is added with three hours for update, and that the use date/time limit included in the use date/time information recorded on the memory card 1 is extended for one month for update. As such, the use restriction update information can update a plurality of conditions regarding the use restriction.

Note that, as in the present embodiment, when the use restriction update information is information indicative of the amount of change of the use restriction information recorded on the memory card 1 after the update by the use restriction update information, the use restriction update table does not have to be generated for each user. Furthermore, when the use restriction update table is not generated for each user, the use request information transmitted from the content use terminal does not include any use identifier.

FIG. 10 is an illustration showing one example of the use restriction update table in another embodiment. In the other embodiment, as illustrated in FIG. 10, the use restriction update information can be information indicative of the limit on the number of uses, the use time limit, or the use date/time limit included in the use restriction information. In this case, the information indicative of the above limit on the number of uses or the like included in the use restriction information recorded on the memory card 1 is updated so as to have the same details as those of the use restriction update information. For example, when the use restriction information includes the number-of-uses information, the limit on the number of uses included in the number-of-uses information is updated so as to have the same limit on the number of uses as those indicated by the use restriction update information.

Also, after transmitting the use restriction update information, the management server 3 has to update the use restriction update information stored in the use restriction update table. This is to prevent a situation in which, when the same user transmits a request for updating the same content data several times, the use restriction update information previously transmitted has the same details as those of the use restriction update information to be transmitted next. Note that, as in FIG. 10, when the use restriction update information is information indicative of conditions for using the content data, the use restriction update information held in the management server 3 side varies for each user. Therefore, the use restriction update information has to be generated for each user.

Returning to the descriptions of FIG. 5, upon transmission of the use restriction update information from the management server 3 to the content use terminal 2, the content use processing section 22 causes the use restriction information updating section 225 to update the use restriction information recorded on the memory card 1 (step S11). That is, according to the details of the use restriction update information transmitted from the management server 3, the use restriction information updating section 225 updates the details of the use restriction information stored in the protected area 13 of the memory card 1. For example, the use restriction update information indicates “time: add three hours, time/date: extend for one month”, the use restriction information updating section 225 updates the use restriction information based on the amount of change indicated by the use restriction update information. That is, the use restriction information updating section 225 accesses the protected area 13 of the memory card 1 to update limit on the number of uses included in the number-of-uses information recorded on the memory card 1 to a value obtained by adding three to the limit on the number of uses. Also, the use date/time information recorded on the memory card 1 is updated so that the date/time (period) indicated by the use date/time information is extended for one month.

After the updating process performed by the use restriction information updating section 225, the content use processing section 22 performs the process of step S105. That is, the content use processing section 22 causes the use deciding section 22 to again perform the above-described use decision process. In this case, the use restriction information recorded on the memory card 1 has been updated, and it is therefore decided that the content data is usable. Accordingly, the content use terminal 2 can execute the content data. This is the end of the descriptions of the process at the content use terminal in the first operation example.

Note that, in the above, the key information can be encrypted and recorded on the protected area 13, and then decoded by a memory-card encryption key generated by mutual authentication performed between the memory card land the content use terminal 2. In this case, if unauthorized access is made to the protected area without performing mutual authorization, the above memory-card encryption key is not generated, and therefore the key information cannot be decoded. Accordingly, the content data cannot be decoded, thereby preventing unauthorized use of the content data. Also, in the above embodiment, assuming that that all pieces of the content data recorded on the memory card have been encrypted and provided with restriction on the use, the content data is specified in step S101 and then mutual authentication is always performed. In another embodiment, however, the pieces of content data may include a piece that has not been encrypted. In this case, the content use terminal 2 has to determine after step S101 whether or not the specified content data has been encrypted. Note that such a determination can be made by referring to the management information recorded on the public area 12. Note that, when the corresponding content data has not been encrypted, the key information preferably has set therein random numbers so as not be noticed as not having been encrypted (if these numbers are all 0, for example, it is obvious at a first glance that the content data has not been encrypted).

A second operation example according to the present embodiment is described next. In the second operation example described below, the use restriction update information is transmitted in arbitrary timing from the management server 3 and, based on the transmitted use restriction update information, the content use terminal 2 updates the use restriction information recorded on the memory card 1. For example, in order to promote the use of specific content data, the management server 3 transmits the use restriction update information of that content data.

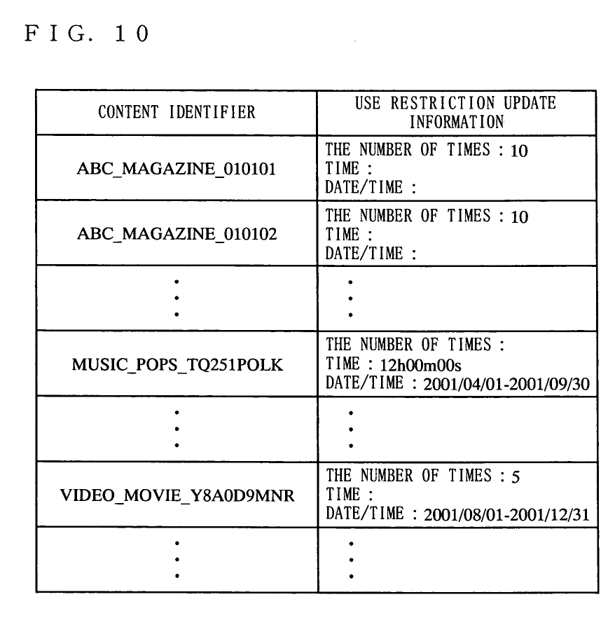

FIG. 11 is a flowchart showing a flow of a process performed by the management server 3 in the second operation example. First, the management server 3 specifies a user to which the use restriction update information is to be transmitted (step S301). The user as a transmission destination can be manually determined by the content provider who manages the management server 3, or can be automatically determined so that transmission is made to only a user who satisfies a certain condition. Alternatively, all user who have been registered on a transmission destination table, which will be described further below, can be determined as transmission destinations. The management server 3 then determines a content use terminal as being a transmission destination of the use restriction update information (step S302). Here, the content use terminal as being a transmission destination of the use restriction update information is determined as follows. That is, the management server 3 holds the transmission destination terminal table that relates the above-described user identifiers to the terminal identifiers which are indicative of information for identifying the respective content use terminals and are unique to the respective content use terminals. By referring to the transmission destination terminal table, the management server 2 can determine, from the user to which the use restriction update information is to be transmitted, a content use terminal for transmission. The management server 3 transmits the use restriction update information to the content use terminal determined in the above-described manner (step S303).

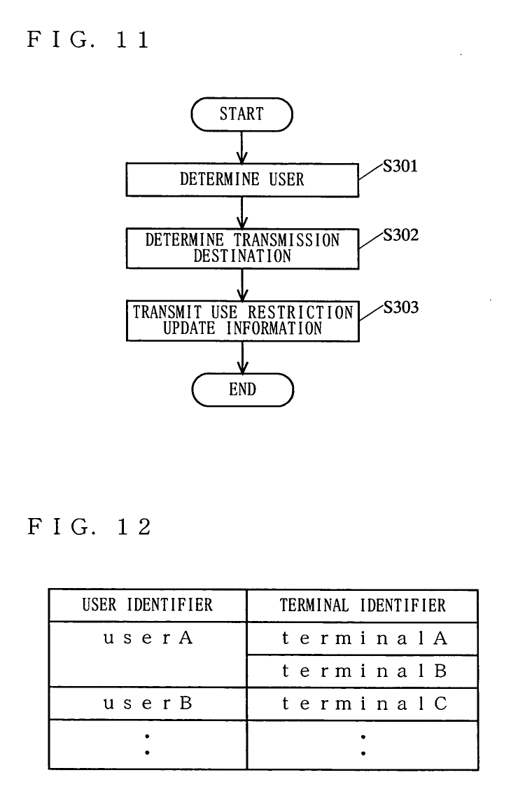

FIG. 12 is an illustration showing one example of the transmission destination terminal table stored in the management table storage section of the management server 3 in the second operation example. The transmission destination terminal table relates the users registered in the present content management system to the content use terminals for use by the users. As illustrated in FIG. 11, the transmission destination terminal table relationally stores a user identifiers and the terminal identifiers. In FIG. 11, a user identifier of “userA” is related to a terminal identifier of “terminalA” and a terminal identifier of “terminalB”. This means that the user having the user identifier of “userA” can use two content use terminals having the terminal identifiers of “terminalA” and “terminalB”. Here, as illustrated in FIG. 11, when the use restriction update information is transmitted to a user having a single user identifier related to a plurality of terminal identifiers, the management server 3 takes all related terminals as transmission destination terminals. For example, when the use restriction update information is transmitted to the user of “userA”, the management server 3 transmits the use restriction update information to the two content use terminals of “terminalA” and “terminalB”.

Also, in the present embodiment, the management server 3 transmits the use restriction update information together with updatable period information regarding the use restriction update information. The updatable period information is information indicative of a period during which the use restriction information can be updated by the use restriction update information. Examples of the updatable period information can be thought, such as information indicating that updating can be made within one month from transmission, or information indicating that updating can be made within the year 2002.

The use restriction update information, the content identifier, and the updatable period information transmitted from the management server 3 are received by each content use terminal. In response, each content use terminal performs a process of updating the use restriction information. The process of updating the use restriction information performed by each content use terminal is described below by taking the content use terminal 2 as an example.

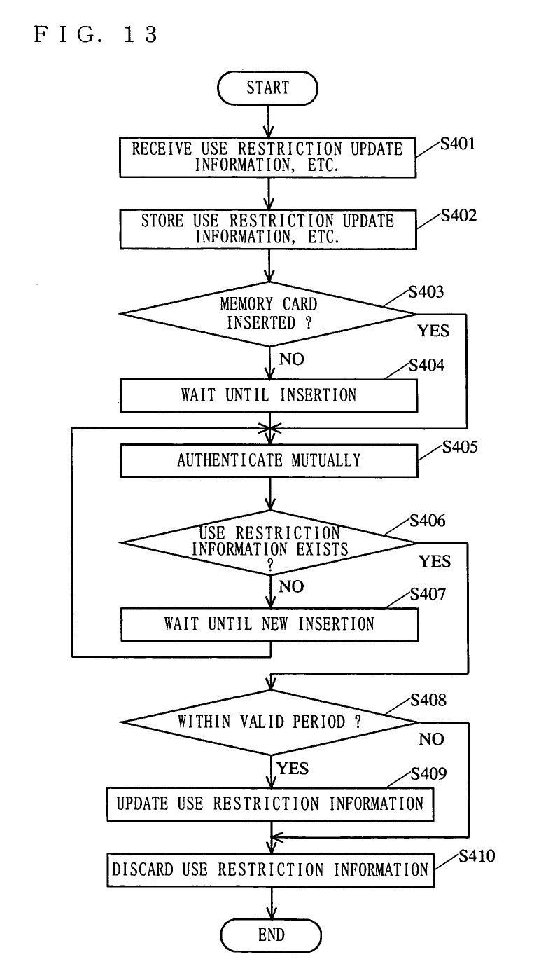

FIG. 13 is a flowchart showing a flow of a process performed by the content use terminal 2 in the second operation example. First, the content use terminal 2 receives the use restriction update information, the content identifier, and the updatable period information transmitted from the management server 3 (step S401). The content use terminal 2 then stores the use restriction update information, the content identifier, and the updatable period information transmitted from the management server 3 in an incorporated storage unit, for example, the main memory 204 illustrated in FIG. 3 (step S402). Here, the information stored in the storage unit is preferably not writable for protection against tampering. The content use terminal 2 then decides whether or not a memory card has been inserted (step S403). In step S403, if a memory card has not been inserted, the content use terminal 2 waits until a memory card has been inserted (step S404). While waiting in step S404, the content use terminal 2 performs other processes including a process not related to the present invention and, upon insertion of a memory card, performs a process of step S405. If a memory card has been inserted in step S403, on the other hand, the content use terminal 2 performs the process of step S405.

In step S405, the content use terminal 2 performs mutual authentication with the memory card inserted therein. Note that, although not shown, if mutual authentication fails, the content use terminal 2 does not perform a process of step S406 and thereafter. Subsequently to step S405, the content use terminal 2 decides whether or not the inserted memory card has the use restriction information corresponding to the information transmitted from the management server 3 (step S406). Specifically, the content use terminal 2 decides whether or not the memory card has recorded therein a content identifier identical to the content identifier transmitted from the management server 3. If there is no corresponding use restriction information in step S406, the content use terminal 2 waits until a memory card is newly inserted (step S407). While waiting in step S406, the content use terminal 2 performs other processes including a process not related to the present invention and, upon new insertion of a memory card, performs the process of step S405.

On the other hand, if there is the corresponding use restriction information in step S406, the content use terminal 2 decides whether or not the use restriction update information is within a valid period (step S408). Specifically, based on the updatable period information stored in step S402, the content use terminal 2 decides whether or not the use restriction information can be updated by the use restriction update information transmitted together with the updateable period information from the management server 3. More specifically, whether or not the use restriction update information is within the valid period is decided by deciding whether or not the period indicated by the updatable period information stored in step S402 has passed. If it is decided in step S408 that the use restriction update information is within the valid period, the content use terminal 2 updates the use restriction information recorded on the memory card (step S409). Specifically, in accordance with the use restriction update information transmitted from the management server 3, the content use terminal 2 updates the use restriction information, which is recorded on the memory card and is with regard to the content data specified by the content identifier transmitted from the management server 3. With the above, the management server 3 can cause the content use terminal 2 to update the use restriction information recorded on the memory card. Subsequent to step S409, the content use terminal 2 performs a process of step S410. If it is decided in step S408 that the use restriction update information is not within the valid period, on the other hand, the content use terminal 2 discards the use restriction update information, which has been decided as being out of the valid period, from the storage unit storing the same (step S410). Also, the content use terminal 2 discards the updatable period information corresponding to the use restriction information. This is the end of the descriptions of the process in the content management system in the second operation example.

A third operation example according to the present embodiment is described next. The third operation example described below is an operation in a case where the user requests for content data related to the content data recorded on the memory card 1 (the former content data is hereinafter referred to as related content data). Specifically, a retrieval request is made for retrieving the related content data from the content use terminal 2 to the management server 3. Furthermore, in response to the retrieval request, the management server 3 transmits the related content data and the use restriction information to the content use terminal 2. According to the above, in a case where the content is like a monthly magazine, for example, if the user has the current-month issue of the content data, the user can easily purchase a next-month issue of the content even not through distribution by a recording medium. Note that, in the third operation example, the content use terminal 2 has to have a function of recording content data or the like on the memory card 1.

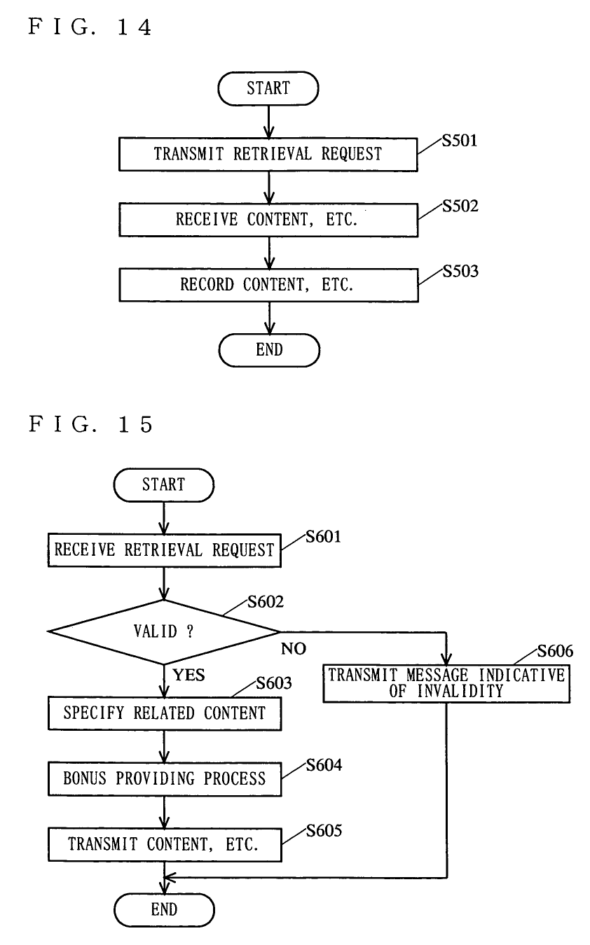

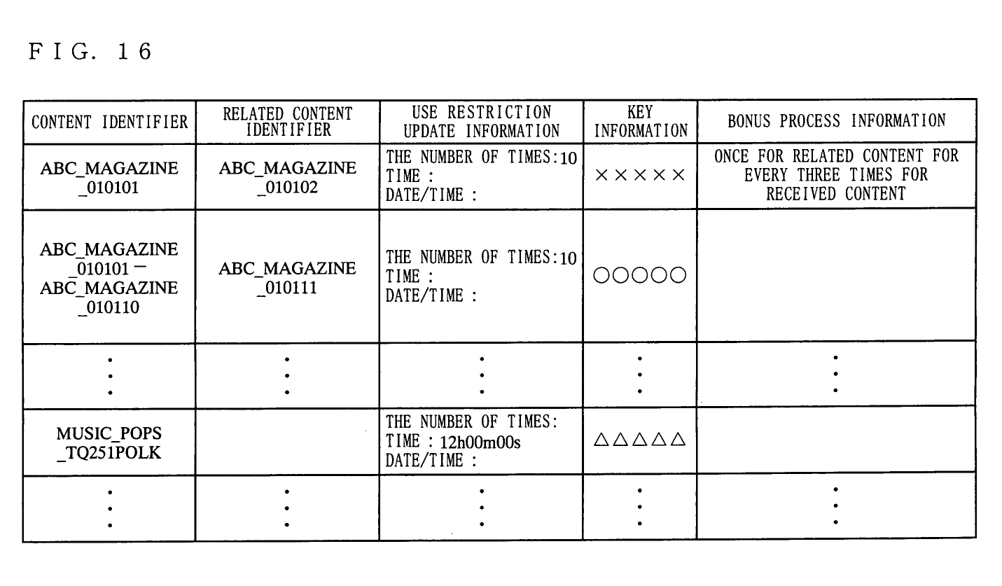

FIG. 14 is a flowchart showing a flow of a process performed by the content use terminal 2 in the third operation example. Furthermore, FIG. 15 is a flowchart showing a flow of a process performed by the management server 3 in the third operation example. With reference to FIGS. 14 and 15, the third operation example is described below. First, the content use terminal 2 transmits retrieval request information regarding the content data to the management server 3 (step S501). The retrieval request information is information indicative of a request for retrieving the content data. In the present embodiment, the retrieval request information includes a content identifier recorded on the memory card 1. That is, in step S501, the content use terminal 2 reads the content identifier recorded on the memory card 1 for transmission as the retrieval request information to the management server 3. Here, it is assumed that, prior to making the retrieval request, mutual authentication has been performed between the content use terminal 2 and the memory card 1. Note that the retrieval request information can include use restriction information corresponding to the content identifier as required.

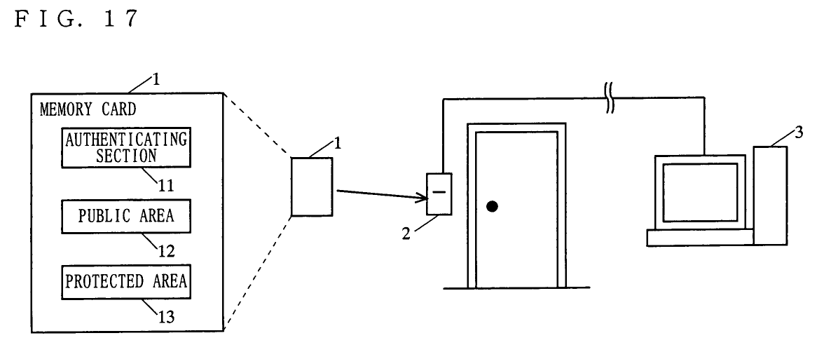

Here, with reference to FIG. 15, the process performed by the management server 3 is described. The management server 3 receives the retrieval request information (step S601) to decide whether or not the retrieval request is valid or not (step S602) Decision in step S602 is made by referring to a related content table. FIG. 16 is an illustration showing one example of the related content table held in the management server 3 in the third operation example.

As illustrated in FIG. 16, the related content table relates content identifiers, related content identifiers, use restriction information, key information, and bonus process information to each other. The related content identifier is a content identifier of the content data related to the content data indicated by the received content identifier. Here, the received content identifier is the content identifier transmitted from the content use terminal 2. Also, the content data indicated by a received content identifier is referred to as received content data. The use restriction information is the one regarding the content data indicated by the corresponding content identifier. The key information is the one for decoding the content data indicated by the corresponding content identifier. The bonus process information is information which is referred to in a bonus process, which will be described below. It is assumed that no bonus process information is set if there is no related content identifier.

Returning to the descriptions of step S602, after receiving the received content identifier, the management server 3 transmits the content data indicated by the corresponding related content identifier to the content use terminal 2. Descriptions are now made by taking FIG. 16 as an example. When receiving a content identifier of “ABC_MAGAZINE_{—}010101”, the management server 3 transmits content data indicated by a content identifier of “ABC_MAGAZINE_{—}010102” to the content use terminal 2. Note that a correspondence between the received content identifier and the related content identifier does not have to be as such that a single received content identifier corresponds to a single related content identifier. For example, a plurality of received content identifiers, such as “ABC_MAGAZINE_{—}010101-ABC_MAGAZINE_{—}010110” (indicating ten content identifiers whose last digits are from 010101 through 010110 in sequence), may correspond to a single related identifier, or vice versa.

Specific examples regarding the correspondence between the received content identifier(s) and the related content identifier(s) include a case where a sequel content is retrieved and a case where a special edition of the content is retrieved. The sequel content is such a content as a next-month issue of the content in contrast to the current-month issue of the content. In this case, the related content table contains the current-month issue of the content and the next-month issue of the content as being related to each other. Also, the special edition of the content is such as one of a series of contents. In one example, a book content has ten volumes of contents, and once the content identifiers corresponding to those contents are all transmitted to the management server 3, a special edition of the book content can be retrieved. In this case, the related content table contains ten volumes of the series of contents and the special edition of the content as being related to each other. As such, from the content data recorded on the memory card, the related content data can be retrieved. With this, it is possible to promote retrieval of a new content and, in turn, to promote the use of contents.

A decision in step S602 is made by deciding, regarding the content identifier received from the content use terminal 2, whether or not the related content table contains the corresponding received content identifier. That is, if the related content table stores the related content identifier corresponding to the content identifier received from the content use terminal 2, the management server 3 determines that the retrieval request is valid. Furthermore, in this case, the management server 3 performs a process of step S603. On the other hand, if the related content table does not store the related content identifier corresponding to the content identifier received from the content use terminal 2 (for example, if “MUSIC_POPS_TQ251POLK” is transmitted in FIG. 16), the management server 3 determines that the retrieval request is invalid. In this case, the management server 3 transmits, to the content use terminal 2, a message indicating that the transmitted retrieval request is invalid (step S606), and then ends the process.

In step S603, the management server 3 specifies the related content data to be transmitted. Specifically, the management server 3 refers to the above related content table to specify the related content identifier corresponding to the received content identifier. The management server 3 then performs a bonus providing process (step S604). The bonus providing process is performed in accordance with the details of the use restriction information transmitted from the content use terminal 2. Therefore, the bonus providing process is performed when the use restriction information is received from the content use terminal 2. That process is not performed when the retrieval request information from the content use terminal 2 does not include the use restriction information. In the present embodiment, as the bonus providing process, the management server 3 changes the details of the use restriction information regarding the related content data to be transmitted. This change is made in accordance with the details of the use restriction information transmitted from the content use terminal 2. Specifically, based on the correspondence indicated by the related content table, the management server 3 determines the details of the bonus process.

A specific example of the bonus providing process in the present embodiment is as follows. For example, in accordance with the limit on the number of uses that is indicated by the use restriction information regarding the received content data (content data indicated by the received content identifier), the limit on the number of uses indicated by the use restriction information regarding the related content data is changed. More specifically, if the limit on the number of uses that is indicated by the use restriction information regarding the received content data is any one of one through five, the limit on the number of uses that is indicated by the use restriction information regarding the related content data is made as five. Also, if the limit on the number of uses that is indicated by the use restriction information regarding the received content data is any one of six through ten, the limit on the number of uses that is indicated by the use restriction information regarding the related content data is made as three. As such, in a specific example of the bonus providing process, when the limit on the number of uses that is indicated by the use restriction information regarding the received content data (the remaining number of times the received content data can be used) is small, the limit on the number of uses that is indicated by the use restriction information regarding the related content data is set relatively larger. This is because, if the number of uses that is indicated by the use restriction information regarding the received content data is small, it can be assumed that the content data has been used a large number of times, and therefore, the related content is also presumed to be used a large number of times. Note that, if the number-of-uses information has recorded therein the total number of uses so far, the limit on the number of uses that is indicated by the use restriction information regarding the related content data can be changed in accordance with the total number of uses.

Another specific example of the bonus providing process in the present embodiment can be thought in which, in exchange for a decrease in the limit on the number of uses that is included in the use restriction information of the received content data, the limit on the number of uses that is included in the use restriction information of the related content data is increased. More specifically, the predefined number of uses indicated by the use restriction information regarding the related content data is increased by one for every three of the limit on the number of uses that is indicated by the use restriction information regarding the received content data (refer to FIG. 16). In this case, the management server 3 transmits the use restriction information regarding the related content data together with the use restriction information regarding the received content data to the content use terminal 2. Here, the use restriction information regarding the received content data is transmitted to the content use terminal 2 in a state where the limit on the number of uses that is received from the content use terminal 2 is decreased by three. In this way, such a specific example of the bonus providing process can be thought as that the number of uses of the related content data is increased in exchange for a decrease in the number of uses of the received content data. With this, the use can increase the number of uses of the newly-retrieved content (the related content), which is more likely to be used, in exchange for a decrease in the number of uses of the old content (the received content), which is less likely to be used. Therefore, such a bonus providing process can promote the use of the related content.

Subsequently to the bonus providing process in step S604, the management server 3 performs a transmitting process (step S605) That is, the management server 3 transmits, to the content use terminal 2, the encrypted content data specified in step S603, the content identifier corresponding to the content data (the related content identifier), the use restriction information corresponding to the content data, and the key information for decoding the content data. Note that the use restriction information and the key information to be transmitted are determined based on the related content table illustrated in FIG. 16. For example, if the content identifier received by the management server 3 is “ABC_MAGAZINE_{—}010101”, related content data indicated by “ABC_MAGAZINE_{—}010102” is specified in step S603 as the related content data. Therefore, in step S605, with reference to a row containing the content identifier of “ABC_MAGAZINE_{—}010102”, the corresponding content use restriction information and key information are determined. As required, in response to the bonus providing process in step S604, the management server 3 transmits, to the content use terminal 2, the use restriction information with its details being changed from the one received from the content use terminal 2. This is the end of the process performed by the management server 3 in the third operation example.

Returning to the descriptions of FIG. 14, the content use terminal 2 receives the content data requested by the retrieval request (the related content data), the content identifier corresponding to the content data, the use restriction information, and the key information from the management server 2 (step S502). The content use terminal 2 then records the received information on the memory card 1 (step S503). Here, the content use terminal 2 records at least the use restriction information, the content identifier, and the key information on the protected area. In the present embodiment, the content use terminal 2 records the content data on the public area as a content file, while recording the use restriction information, the content identifier, and the key information on the protected area. Note that, when the use restriction information with its details being changed from the one transmitted from the content use terminal 2 to the management server 3 is transmitted from the management server 3 as a result of the bonus providing process, the content use terminal 2 updates the details of the use restriction information in the memory card 1. This is the end of the descriptions of the process in the content management system in the third operation example.

Note that, in the present operation example, what is transmitted as a retrieval request is the retrieval request information including the content identifier of the content data related to the content data requested by the retrieval request. In another embodiment, however, retrieval request information including the content identifier of the content data requested by the retrieval request itself can be transmitted. In this case, there are two types of retrieval request that should be discriminated: one is a retrieval request for retrieving content data related to the content data indicated by the content identifier to be transmitted, and the other is a retrieval request for retrieving the content data indicated by the content identifier to be transmitted. Therefore, the content use terminal 2 has to transmit information for discriminating these two types of retrieval request as being included in the retrieval request information. Also, other than the above related content table, the management server 3 has to hold a table for relating the content identifiers to the pieces of content data indicated thereby.

Note that, in the above first embodiment, the use restriction information recorded on the protected area 13 of the memory card 1 includes the number-of-uses information, the use time information, and the use date/time information. In another embodiment, however, the use restriction information is not restricted to the above. For example, the use restriction information may represent the amount of uses as being converted to points. Also, the use restriction information does not have to include all of the above three pieces of information, but may include either one or two of these. Furthermore, the protected information may include a check value for checking to see if the use restriction information and the content identifier have been tampered. Note that the check value may be any as long as it corresponds to the use restriction information and the content identifier, and may be stored in a file other then the protected information file 131.

Furthermore, in the first embodiment, the use restriction information (the number-of-uses information, the use time information, the use date/time information) is information composed of values indicative of predetermined use restriction conditions and values indicative of the total results of use so far. For example, the number-of-uses information is composed of the predetermined limit on the number of uses and the total number of uses so far. Here, in another embodiment, the use restriction information may be information indicative of only conditions for using the content data. For example, the number-of-uses information may be information indicative of a number of times the content data can be used. In this case, the number-of-uses information indicates that the content data can be used twice more, for example. Then, when the content data is used, the content use terminal updates the number-of-uses information recorded on the memory card. Further, the use restriction update information may be in a format identical to that of the use restriction information. That is, the use restriction update information may be information indicative of conditions for using the content data. At this time, the content use terminal 2 updates the use restriction information recorded on the protected area of the memory card 1 so that the use restriction information has the same condition as those indicated by the use restriction update information transmitted from the management server 3. For example, when the use restriction update information indicates that the number of times the content data can be used is ten, the content use terminal receiving the use restriction update information updates the use restriction information recorded on the protected area of the memory card 1 so that the content data can be used ten times more. As described above, the use restriction information can have the same format as that of the use restriction update information.

Still further, in the above first embodiment, the memory card 1 has the public area 12 and the protected area 13. In another embodiment, however, the memory card may have only the public area 13. In this case, all files are placed in the protected area 13. Still further, in the above first embodiment, the memory card 1 is used as the information recording medium. Alternatively, another information recording medium can be used, such as a disk or a tape.

Still further, in the above first embodiment, the management server 3 can perform a billing process in response to a content data use request and a content data retrieval request. That is, in response to the use request or the retrieval request, the management server 3 transmits the use restriction update information and the use restriction information to the content use terminal 2, and also may perform billing in accordance with the transmitted use restriction update information and the use restriction information. More specifically, a billing process can be performed in the process of transmitting the use restriction information in step S204 shown in FIG. 9 or in the process of transmitting the content and others in step S605 shown in FIG. 15. For example, upon a determination of the use restriction update information in step S203, a billing process is performed on the user specified in step S202 in accordance with the details of the use restriction update information determined in step S203. Also, the timing of the billing process is not restricted to the transmitting process, but the billing process may be performed in response to the process of determining the use restriction information in step S203, for example. Still further, as the bonus providing process in the third operation example, the management server 3 may perform a process so that the billing amount is changed in accordance with the use restriction information transmitted from the content use terminal 2. For example, the billing amount can be decreased (a discount amount is increased) as the limit on the number of uses indicated by the use restriction information is decreased.

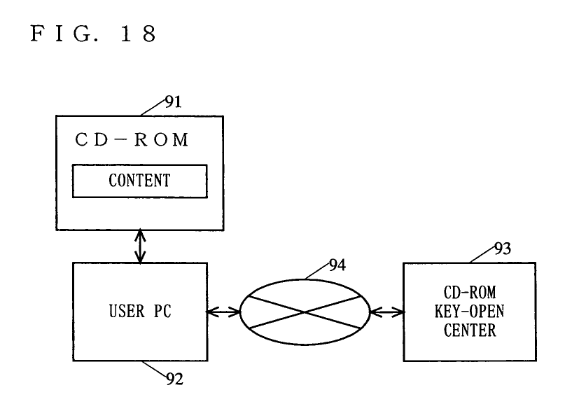

Next, as a second embodiment of the present invention, another example of use of the content management system is described. The second embodiment shows that the content management system according to the present invention is used for a door locking system in accommodations, such as hotels. FIG. 17 is an illustration conceptually showing the configuration of the content management system according to the second embodiment. Note that the system of the present embodiment can be achieved by using the components of the content management system in the first embodiment. Therefore, the components identical to those in the content management system according to the first embodiment are provided with the same reference numbers. The content management system includes a memory card 1, which is a card key for a door, a content use terminal 2, which is a locking device of the door, and a management server 3 for managing the locking device of the door.

Upon insertion of the memory card 1 serving as the card key into the content use terminal 2 serving as the locking device of the door, mutual authentication is performed between the memory card 1 and the content use terminal 2. Through such mutual authentication, the content use terminal 2 can access the protected area of the memory card 1. Here, the public area of the memory card has recorded therein, as content data, a character string for unlocking the door. The doors of the rooms in the accommodations have respectively set therein different character strings. That is, the doors of the rooms in the accommodations a reset so as to be unlocked by different character strings. Also, the protected area has recorded therein conditions for using the character string. Here, it is assume in the present embodiment that a date/time (period) when the character string can be used is recorded as the use restriction information. More specifically, it is assumed that the use restriction information indicates a period during which the user (guest) can stay. Moreover, the protected area has recorded therein a content identifier for identifying the content data.

Subsequently to mutual authentication, the content use terminal 2 reads the use restriction information recorded on the protected area. Furthermore, based on the read use restriction information, the content use terminal 2 decides whether or not the content data (the character string for unlocking the door) can be used. Specifically, the content use terminal 2 decides from the use date/time limit and the current date/time whether the character string for unlocking the door can be used. In the present embodiment, if the content data is usable, that means that the guest can use the room. On the other hand, if the content data is not usable, that means that the guest cannot use the room. For example, if a scheduled check-in date has been passed or a check-out time has been passed, the current time is not within a period of the use date/time limit, and therefore the guest cannot use the room.

If it is decided that the content data is usable, the content use terminal 2 uses the character string to unlock the door. If it is decided that the content data is not usable, on the other hand, the content use terminal 2 transmits information about a request for using the content data to the management server 2. This use request information includes a content identifier recorded on the protected area. In response to the use request from the content use terminal 2, the management server 3 decides whether or not to transmit the use restriction update information. In the present embodiment, such a decision process is to decide whether or not the guest can make an extended stay (extend his or her stay). For example, the management server 3 searches a room reservation database for a reservation state of the room from which the use request information was transmitted. As a result of search, if the room from which the use request information was transmitted has not been reserved, it is decided to transmit the use restriction update information. Conversely, if the room from which the use request information was transmitted has been reserved, it is decided not to transmit the use restriction update information. As a result of decision, when the use restriction update information is transmitted to the content use terminal 2, the content use terminal updates the use restriction information of the memory card 1 in accordance with the use restriction update information. Furthermore, the content use terminal 2 reads the character string for unlocking the door from the memory card 1 to unlock the door by using the character string. In this way, the content management system according to the present invention can also be applied to the door locking system in accommodations.

As such, according to the present invention, a content management system is provided in which whether or not the content data is usable is decided based on the use restriction information recorded on a recording medium, thereby enabling a content provider side to restrict the use of contents in more detail.

Note that, in the present invention, the content data is encrypted, and the key information for decoding the content data is recorded on the protected area. Therefore, the content use terminal does not have to hold information necessary to use the content (the key information and the use restriction information), and does not have to obtain the key information whenever using the content. Therefore, when the content data previously used in another terminal is used, the content can be easily used. That is, in a conventional method in which the terminal obtains the key information from the management server, the terminal has to newly obtain the key information from the server (even if the key is held in another terminal to be used by the same user). On the other hand, according to the present invention, as long as the conditions in the use restriction information are satisfied, the content use terminal does not have to communicate with the management server. Therefore, this can simplify a process when a content recorded on a recording medium is used by a plurality of devices.

### INDUSTRIAL APPLICABILITY

As has been described in the foregoing, the content management system of the present invention can be used in order for a content provider side to restrict the use of contents in more detail.

1. (Amended) A content management system in which content data recorded on a portable-type recording medium is used by a content use terminal, comprising:
the content use terminal;
a recording medium removably inserted to the content use terminal; and
a management server communicable with the content use terminal,
the recording medium including:
a content data recording section which records encrypted content data;
a medium-side authenticating section which performs authentication with the content use terminal; and
a protected area which records therein protected information of which reading from outside is restricted, the protected information including use restriction information indicative of conditions for using the encrypted content data and key information for decoding the encrypted content data, and
the content use terminal including:
a terminal-side authenticating section which performs mutual authentication with the recording medium in cooperation with the medium-side authenticating section;
a protected information reading section which reads the protected information from the protected area of the recording medium only upon a success of the mutual authentication performed by the terminal-side authenticating section with the recording medium;
a use deciding section which decides, based on the use restriction information included in the protected information read by the protected information reading section, whether or not the content data recorded on the recording medium is usable;
a content decoding section which decodes, upon a decision made by the use deciding section that the content data recorded on the recording medium is usable, the content data encrypted and recorded on the recording medium by using the key information included in the protected information read by the protected information reading section; and
a content executing section which executes the content data decoded by the content decoding section, wherein
the management server transmits, to the content use terminal, use restriction update information for updating the use restriction information,
the terminal-side authenticating section performs mutual authentication with the recording medium upon a receipt of the use restriction update information from the management server, and
the content use terminal further includes:
an updating section which updates, in accordance with the use restriction information transmitted from the management server, the use restriction information recorded in the protected area of the recording medium only upon success of the mutual authentication performed by the terminal-side authenticating section with the recording medium;
a use restriction update information storage section which stores the use restriction update information transmitted from the management server; and
a use restriction information deciding section which makes a decision whether or not the protected information recorded on the recording medium includes use restriction information corresponding to the use restriction update information stored in the use restriction update information storage section, the decision being made only upon a success of the mutual authentication performed by the terminal-side authenticating section with the recording medium,
upon new insertion of a recording medium, the terminal-side authenticating section performs mutual authentication with the newly-inserted recording medium, and
upon a decision made by the use restriction information deciding section that the use restriction information corresponding to the use restriction update information stored in the use restriction update information storage section is included, the updating section updates the use restriction information recorded on the recording medium in accordance with the use restriction update information stored in the use restriction update information storage section.

2. The content management system according to claim 1 wherein
the content use terminal further includes a use requesting section which transmits, upon a decision by the use deciding section that the content data recorded on the recording medium is not usable, use request information indicative of a request for using the content data decided as not being usable,
upon a receipt of the use request information from the use requesting section of the content use terminal, the management server transmits, to the content use terminal, use restriction update information regarding the content data requested by the transmitted use request information, and
upon an update performed by the updating section of the use restriction information recorded on the protected area, the content decoding section decodes the content data regarding the updated use restriction information.

3. The content management system according to claim 2, wherein
the protected information further includes a content identifier for identifying the content data recorded on the recording medium,
the use requesting section transmits, to the management server, as a use request, use request information including the content identifier indicative of the content data requested by the use request, and
the management server transmits, to the content use terminal, the use restriction update information regarding the content data indicated by the content identifier transmitted from the use requesting section of the content use terminal.

4. The content management system according to claim 1, wherein
the use restriction update information is information indicative of conditions for using the content data, and
the updating section updates the use restriction information recorded on the protected area of the recording medium so that conditions indicated by the use restriction information are identical to the conditions indicated by the use restriction update information transmitted from the management server.

5. The content management system according to claim 1, wherein
the use restriction update information is information indicative of an amount of change in the use restriction information recorded on the recording medium between before and after the update, and
based on the amount of change indicated by the use restriction update information transmitted from the management server, the updating section updates the use restriction information recorded on the protected area of the recording medium.

6. (Deleted)

7. (Amended) The content management system according to claim 1, wherein
the content use terminal further includes a discarding section which discards, upon an update by the updating section of the use restriction information, the use restriction update information corresponding to the updated use restriction information from the use restriction update information storage section.

8. (Amended) The content management system according to claim 7, wherein
the management server transmits, to the content use terminal, the use restriction update information together with updatable period information indicative of a period during which the use restriction information can be updated by the use restriction update information,
the use restriction update information storage section further stores the updatable period information transmitted from the management server,
the content use terminal further includes an update deciding section which decides, based on the updatable period information stored in the use restriction update information storage section, whether or not the use restriction information recorded on the recording medium is to be updated, upon a decision made by the use restriction information deciding section that the use restriction information corresponding to the use restriction update information stored in the use restriction update information storage section is included,
the updating section updates the use restriction information only upon a decision made by the updating decision section that the use restriction information is to be updated, and
upon a decision made by the update deciding section that the use restriction information is not to be updated, the discarding section discards the use restriction update information and the updatable period information corresponding to the use restriction information decided as being not to be updated from the use restriction update information storage section.

9. The content management system according to claim 1, wherein
the content use terminal further includes a retrieval requesting section which transmits retrieval request information indicative of a retrieval request for requesting a retrieval of the content data to the management server; and
a recording section which records in the recording medium, only upon a success of the mutual authentication performed by the terminal-side authenticating section with the recording medium, information transmitted from the management server in response to the retrieval request information transmitted from the retrieval request,
the management server transmits, to the content use terminal, the encrypted content data indicated by the retrieval request information transmitted from the retrieval requesting Section of the content use terminal, the use restriction information regarding the content data, and the key information for decoding the content data, and
the recording section records at least the use restriction information and the key information of the information transmitted from the management server in the protected area.

10. The content management system according to claim 9, wherein
the protected area has further recorded therein a content identifier for identifying a content recorded on the recording medium,
the retrieval requesting section transmits information including the content identifier recorded on the recording medium as the retrieval request information at the time of retrieving the content data related to the content data recorded on the recording medium, and
the management server transmits, to the content use terminal, the encrypted content data which corresponds to content data indicated by a content identifier transmitted from the retrieval requesting section., the use restriction information regarding the content data, and the key information for decoding the content data.

11. The content management system according to claim 10, wherein
in addition to the content identifier, the retrieval requesting section transmits, to the management server, the use restriction information corresponding to the content data indicated by the content identifier, and
the management server changes details of the use restriction information to be transmitted to the content use terminal in accordance with details of the use restriction information transmitted from the retrieval requesting section.

12. The content management system according to claim 1, wherein
the use restriction information includes at least one of number of uses limit information indicative of the number of times the content data recorded on the recording medium can be used, time limit information indicative of a time during which the content data recorded on the recording medium can be used, and date/time limit information indicative of a date/time by which the content data recorded on the recording medium can be used.

13. A portable-type information recording medium removably attached to a content use terminal using content data, comprising:
a content data recording section which records encrypted content data;
a medium-side authenticating section which performs authentication with the content use terminal as a part of a mutual authentication process performed with the content use terminal; and
a protected area which records protected information including a content identifier for identifying the content data, use restriction information indicative of conditions for using the encrypted content data, and key information for decoding the encrypted content data, the protected information of which reading from outside being restricted, wherein
the protected area can be read by the content use terminal only upon a success of the mutual authentication process performed with the content use terminal.

14. The information recording medium according to claim 13, therein
the use restriction information includes at least one of number-of-uses limit information indicative of the number of times the content data can be used, time limit information indicative of a time during which the content data can be used, and a date/time limit information indicative of date/time by which the content data can be used.
